(19) United States
(12) Patent Application Publication
(10) Pub. No.: US 2003/0224855 A1
(43) Pub. Date: Dec. 4, 2003

(54) Optimizing location-based mobile gaming applications

(76) Inventor: Robert Cunningham, Plano, TX (US)

Correspondence Address: SCHEEF & STONE, L.L.P., 5956 SHERRY LANE, SUITE 1400, DALLAS, TX, 75225, US

(21) Appl. No.: 10/160,365

(22) Filed: May 31, 2002

(51) Int. Cl. A63F 13/00

(52) U.S. Cl. 463/41

(57) ABSTRACT

A system and method for optimizing the process of position-determining to enhance performance of location-based mobile gaming applications. A position-determining module is provided that uses one or more of a number of position-determining methodologies to determine a player's real geographical position, which information is then used to influence the execution of the mobile-gaming application and, in a preferred embodiment, the method by which mobile-gaming data is transmitted to the player. The various position-determining methodologies may be used in isolation, with the game server determining which to use based on the particular application being executed, and on its execution state. They may also be used together and for greater accuracy combined according to a set of predefined criteria.

The present invention relates generally to the field of mobile gaming applications, and more specifically to a system and method for optimizing positioning accuracy and data routing in a location-based mobile game environment.

### BACKGROUND OF THE INVENTION

An electronic game is a form of game entertainment in which the player interacts with an electronic device that has been programmed for this purpose. Mobile gaming refers to network-based electronic games or game-like applications that are played by a user who is, or who at least has the ability to be mobile while play is in process. In other words, mobile gaming is not simply the carrying of a portable electronic device on which a game may be played, but rather one having network-based communication capability for extending game functions, when desirable, beyond the device itself. In this way, the game-playing experience is significantly enhanced by giving the player access to computer-processing and data-storage resources will beyond those available on the electronic device alone, which is generally portable in nature. These resources are frequently made available on a central computing device, often called a game server, which is also in communication with the network. These gaming resources do not have to be centralized, however, and may alternately be widely distributed.

In addition to potential access to large computing resources, mobile gaming may permit communication between two, or any number of other players for the purpose of collaboration or competition in playing the game. This communication may be direct, with players exchanging voice or text messages, or indirect. Indirect communication means that various users may simply have the ability to affect the game environment, that is, the artificially-created set of elements and circumstances, sometimes referred to as “virtual space”, with which they or other players interact while playing the game. They may do this, of course, with or without knowledge of the other player's position in real or virtual space.

Not uncommonly, mobile game players make use of portable electronic gaming devices that have other uses as well. These other functions may actually be the predominant reason the user has the device in the first place, or they may be merely secondary to the game-playing function. On example is a mobile telephone that is predominantly used for cellular telephone calls, and perhaps for related services as well. These related services may including applications such as paging, messaging, calendaring, and Internet access, and each such function may in fact be useful for both the gaming and the non-game applications. Again, to be considered “mobile gaming” as that term is used herein, the electronic device involved will include the ability to communicate with some form of network through which the game is played or facilitated. The mobile-gaming device, however, may also have the ability to support game play on a stand-alone basis when necessary or desirable, and network-based game play may involve only intermittent, as opposed to continuous, contact through the communications network.

Note that various communicating electronic devices are now available, and the game-playing device itself may also be a mobile telephone, pager, personal digital assistant (PDA), or similar device. The advantage of such a versatile device, of course, is that the user need only carry a single electronic device in order to perform any of these various functions. The mobile gaming function may in fact make use of many of the components already present to perform the other functions. For convenience herein, the term “mobile gaming station” (and the initials “MGS”) will refer to all of these communications-capable devices through which the mobile gaming is performed, without regard to whether mobile gaming is a predominant or a secondary function of the device. Naturally, such devices that are only used for mobile gaming are also included within this definition, as are those capable of supporting both mobile gaming and, in addition, game-play applications that do not fall into the category of mobile-gaming.

The games that can be played on a mobile gaming station vary widely. Some are fairly simple such as trivia games where a player answers questions by choosing from among listed answers. Others are extremely complex, involving challenges that may take days for even the most sophisticated players to conquer. Some games involve only rational thought processes, while others test manual dexterity by requiring rapid responses to provided stimuli. Not unexpectedly, many games combine some or all of these elements.

Although most mobile games are for entertainment, the creation of an interactive virtual space on a mobile gaming station also lends itself to other applications as well. Training and testing of emergency-response teams, for example, can be conducted by providing them with mobile gaming stations that create for them an artificial emergency where none exists in reality. The teams learn the proper procedures through trial and error in this artificial environment, where the consequences of error are not so grave. The network-connection aspect of the mobile gaming also permits easier monitoring of performance by a non-player, a function that may be performed by a human or an automated operator. The operator may also overtly influence the virtual space in which the participants (players) are operating (playing), which permits flexibility in the training exercise.

Whether the mobile games are for pure entertainment or for some other application, the game experience may be enhanced through the use of location-based virtual-space influences. A location-based influence is one having an effect on the virtual space that is dependent on the real geographical location of the player, or on a change in location. A given player's virtual space may also be affected by the location or relocation of another player or players. In other words, the player's game experience can be tailored to in some way bear a closer resemblance to the player's reality. One way of doing this is simply to adjust the game environment to match that actually being experienced by the player. For example, the virtual space may appear to be the indoors of a building, the streets of a city, or a pastoral setting—coinciding and changing to match the player's location. Another way of tailoring a virtual space is based on the player's proximity to a goal located in the real world, perhaps a natural landmark, a hidden object, or a large monument. Yet another way involves the player's proximity to another player or players, where one object of the game might involve spotting, meeting, or avoiding them. Indicating proximity may be done inferentially, such as when a game character moves closer to or farther away from a fictional destination or simply appears to get “colder” or “warmer”. Many other variations are possible as well.

The location of a player, absolutely or in relation to other players, may also be used to determine the optimum method for communicating with the network or other players at a particular time. Mobile games often rely for their success on the rapid and reliable transmission of data on an economical basis. Excess use of valuable network resources may be unnecessarily expensive, and ultimately limit the speed of game execution and the number of players that can play. If nothing else, repeatedly unreliable transmissions may give rise to widespread consumer (player) dissatisfaction. All of these consequences are to be avoided where possible. Determining the location of a player or of several interacting players, as explained below, may be used to support more efficient and reliable delivery in situations where it is needed or desired.

In each of these examples, however, it is necessary to determine player location with some degree of accuracy. There are a variety of methods for doing this, the most apparent being the use of a simple query. Players in a location-based game may be instructed up front to periodically communicate information to a game server about their location or environment in some way, or they may be prompted to do so from time to time. Although fairly accurate location information may be maintained using this method, in many cases it may result in an undesirable distraction during game play. And of course it is dependant on the players being able to accurately reckon their position. In games where location information for many players is needed, it may also be difficult to get everyone to update their status on a sufficiently regular and timely basis.

Automated location-determination systems also exist, some fully automatic and others requiring some initiation or cooperation by the player being located, or by some other player or a human operator. As explained more fully below, some location determination methods are intrinsic to the network through which they communicate. That is, in a network that already accommodates mobile users, an estimation of location may frequently be made by determining which network node is being used to communicate with the mobile device. A more accurate determination may be possible where numerous sensors have been place in an area such as a college campus, shopping mall, or military installation, the sensors being numerous and precise enough to determine when a user has entered one defined area or left another. Such systems are not yet in general use, but will presumably be limited to areas where the expense of installing such a system is justified by it's utility. This utility, of course, is not limited to mobile gaming and existing systems may well be modified to accommodate mobile-game players.

Other systems rely on larger networks having a main purpose of providing location-determining capability, such as the Global Positioning System (GPS). Briefly, GPS is a collection of twenty-four (or more) earth-orbiting satellites that continuously transmit time-coded signals, which upon reception can be analyzed to make a relatively accurate position determination virtually any unobstructed location on the earth's surface. The equipment required to make use of the satellite signals remains relatively expensive, however, and while the position-determination accuracy may be sufficient for general navigation, it may not be so for sophisticated location-based gaming applications.

In addition, it is almost uniformly true that the more accurate and widely available a given location-determination system is, the more expensive it will be. This expense may be incurred by a subscribing player either in utilizing the system or in buying equipment in order to have to capability to do so. No one position-determining system is standard, and the cost of acquiring the capability to use one particular method that is only available or useful in limited situations may be prohibitive for most individuals. On the other hand, if many alternate systems were made available to a wide variety of users by a network owner or operator, the cost of utilizing them may be spread out, and therefore generally more affordable. At the same time, doing so will also enhance the game-playing experience for subscribers because the potential for accuracy and precision is improved. Finally, the use of multiple systems helps to facilitate economy in data transmission, and in some cases provides opportunities for the provisioning of a revenue-generating service by network operators. The present invention provides just such a solution.

### SUMMARY OF THE INVENTION

In one aspect, the present invention is a system for optimizing location-based mobile gaming conducted through a communication network. The system includes a position-determining function that determines the position of a mobile gaming station using at least two different position-determining methodologies. The position-determining function may be present on a mobile gaming station or on a game server in communication with the network. The position-determining methodologies may, for example, use the global positioning system (GPS), the enhanced-observed time difference (E-OTD) system, or a more locally-based protocol such as Bluetooth. The methodology actually selected for use varies according to the mobile-gaming application being used, the state that the mobile-gaming application is in, and where enabled, according to the option selected by the player or game-network operator. In a preferred embodiment, two or more position-determining methodologies are used at the same time, and any variation is result is taken into account in making a final position determination. This may be done by averaging or combining the different results, perhaps giving more weight to one than to another. Or it may be done by choosing a preferred one of a plurality of obtained results according to a predetermined or dynamically generated set of criteria.

In another aspect, the present invention is a method of providing for location-based mobile gaming in a communications network including the steps of providing a game server that determines when a position determination should be made, and which of a plurality of available methodologies is to be used to make it. The position determination may be made using only one methodology selected according to predetermined criteria such as the type of mobile-gaming application currently in use, according to the accuracy necessary to the particular state the application is in, or according to any player input that is available. A plurality of the available methodologies may also be used, each of which will independently make a position determination. The plurality of such determinations may then be combined. In a particularly preferred embodiment, the determined player position is used not only to adjust the game-playing virtual space, but also to determine the optimum manner in which data is to be delivered to the player.

### BRIEF DESCRIPTION OF THE DRAWINGS

For a more complete understanding of the present invention, and the advantages thereof, reference is made to the following drawings in the detailed description below:

FIG. 1 is a block diagram illustrating selected components of a wireless communications network for mobile gaming according to an embodiment of the present invention.

FIG. 2 is a sketch illustrating the operation of position determination using the Global Positioning System (GPS).

FIG. 3 is a sketch illustrating the operation of position determination using an enhanced-observed time difference (E-OTD) system.

FIG. 4 is an illustration depicting a mobile gaming station for use according to an embodiment of the present invention.

FIG. 5 is a functional block diagram illustrating the interrelationship of selected components of the mobile gaming station of FIG. 4, operable in accordance with an embodiment of the present invention.

FIG. 6 is a flow chart illustrating a method of providing location-based mobile gaming according to an embodiment of the present invention.

FIG. 7 is a block diagram illustrating the configuration of a sensor platform according to an embodiment of the present invention.

### DETAILED DESCRIPTION

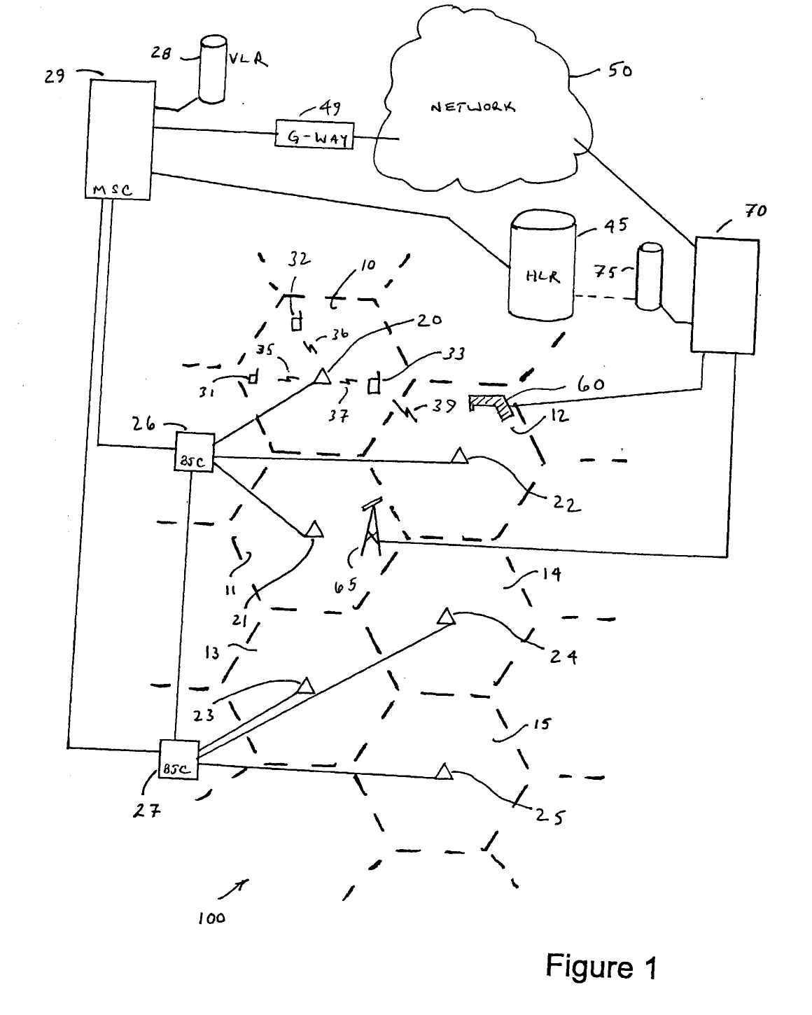

FIGS. 1 through 7, discussed herein, and the various embodiments used to describe the present invention are by way of illustration only, and should not be construed to limit the scope of the invention. Those skilled in the art will, in light of this Specification, understand the principles of the present invention and how they may be implemented in a variety of ways in addition to those specifically discussed herein.

The present invention is directed to the optimization of location-based mobile gaming applications. As mentioned above, the electronic devices used for mobile gaming are frequently instruments used for other functions as well. For example, in one embodiment the present invention is applied in a wireless telecommunication system using properly-adapted mobile gaming stations (MGSs). One reason wireless networks are ideal for mobile gaming is because wireless mobile telephones have become ubiquitous in modem society. Once the property of the affluent or those in specialized occupations, mobile phones—sometimes called cell phones—are now available to the general population. Driving this popularity are advances in technology that have increased both the quality and capacity of wireless networks. At the same time, these technological advances resulted in reduced costs, both for the mobile phones themselves and for a subscription to the network for service. While modification of ‘standard’ mobile phones, such as providing larger displays with higher resolutions, may be desirable to enhance the mobile-gaming experience, most modem phones are capable of functioning as basic mobile gaming stations with little alteration.

In this embodiment, the mobile-gaming application takes advantage of a mobile phone's computing capability in playing a game, and its communications capability to access game-playing resources that are also in communication with the network. The variety of game-playing experiences thereby available to the user is vast, and the number of potential game players virtually unlimited. And where, as is typical, the wireless communication network is run by a for-profit operator that provides a number of fee-based services, additional revenue opportunities are presented. An embodiment of the present invention applied in a wireless communication network will now be described. Although the present invention will now be described in this embodiment, however, other types of networks may be used as well.

FIG. 1 is a simplified block diagram illustrating the configuration of a typical wireless telecommunication network, sometimes referred to as a public land mobile network (PLMN) 100, connected for use according to an embodiment of the present invention. The entire geographic area (not shown in FIG. 1) covered by such a network is divided into a number of cells, such as cells 10 through 15 delineated by broken lines in FIG. 1. Although only six cells are shown, there are typically a great many, and they may vary in size and shape. In the illustrated embodiment, each cell has associated with it a base transceiver station (BTS) for example BTS 20 for transmitting and receiving messages to and from mobile gaming stations (MGSs) in cell 10, here MGS 31, MGS 32, and MGS 33, via radio frequency (RF) links 35, 36, and 37, respectively. Mobile gaming stations MGS 31 through MGS 33 are usually (though not necessarily) mobile, and free to move in and out of cell 10. Although the communication terminals depicted in FIG. 1 are described as mobile gaming stations, note that the PLMN 100 also communicates with other terminals as well, not all of which are used for mobile gaming. Radio links 35-37 are established only where necessary for communication. When the need for a particular radio link no longer exists, the associated radio channels are freed for use in other communications. (Certain channels, however, are dedicated for beacon transmissions and are therefore in continuous use.) BTS 21 through BTS 25, located in cell 11 through cell 15, respectively, are similarly equipped to establish radio contact with mobile gaming stations (not shown) in the cells that they cover.

BTS 20, BTS 21, and BTS 22 operate under the direction of a base station controller (BSC) 26, which also manages communication with the remainder of PLMN 100. Similarly, BTS 23, BTS 24, and BTS 25 are controlled by BSC 27. In the PLMN 100 of FIG. 1, BSC 26 and 27 are directly connected and may therefore both communicate and switch calls directly with each other. Not all BSCs in PLMN 100 are so connected, however, and must therefore communicate through a central switch. To this end, BSC 20 is in communication with mobile switching center MSC 29. MSC 29 is operable to route communication traffic throughout PLMN 100 by sending it to other BSCs with which it is in communication, or to another MSC (not shown) of PLMN 100. Where appropriate, MSC 29 may also have the capability to route traffic to other networks, such as a network 50. Network 50 may be the Internet, an intranet, a local area network (LAN), or any of numerous other communication networks that transfer data, usually via a packet-switching protocol. Data passing from one network to another will typically though not necessarily pass through some type of gateway, which not only provides a connection, but converts the data from one format to another, as appropriate.

A cellular telephone wireless system such as the one illustrated in FIG. 1 has several advantages over a central-antenna system. As the cells are much smaller than the large geographic area covered by a central antenna, transmitters do not need as much power. This is particularly important where the transmitter is housed in a small device such as a cell phone. In addition, the use of low-power transmitters means that although the number of them operating in any one cell is still limited, the cells are small enough that a great many may operate in an area the size of a major city. The mobile gaming stations do not transmit with enough power to interfere with others operating in different cells (not adjoining the one they are in). In some systems, this enables frequency reuse, that is, the same communication frequencies can be used in non-adjacent cells at the same time without interference. In other systems codes used for privacy or signal processing may be reused in a similar manner.

In addition to the cellular architecture itself, certain multiple access schemes may also be employed to increase the number of mobile gaming stations that may operate at the same time in a given area. In frequency-division multiple access (FDMA), the available transmission bandwidth is divided into a number of channels, each for use by a different caller (or for a different non-traffic use). A disadvantage of FDMA, however, is that each frequency channel used for traffic is captured for the duration of each call and cannot be used for others. Time-division multiple access (TDMA) improves upon the FDMA scheme by dividing each frequency channel into time slots. Any given call is assigned one or more of these time slots on which to send information. More then one caller may therefore use each frequency channel. Although the channel is not continuously dedicated to them, the resulting discontinuity is usually imperceptible to the user. For data transmissions, of course, the discontinuity is not normally a factor, as long as it is accounted for when packetizing the data.

Code-division multiple access (CDMA) operates somewhat differently. Rather than divide the available transmission bandwidth into individual channels, individual transmissions are spread over a frequency band and encoded. By encoding each transmission in a different way, each receiver (i.e. mobile gaming station) decodes only information intended for it and ignores other transmissions. The number of mobile gaming stations that can operate in a given area is therefore limited by the number of encoding sequences available, rather than the number of frequency bands. Note that in a preferred embodiment of the present invention, mobile gaming stations are manufactured to operate in accordance with a number of different multiple-access schemes.

Returning to FIG. 1, when a mobile gaming station, for example MGS 33, leaves cell 10 and enters cell 12, its communication link to the network is transferred from BTS 20 to BTS 22. If MGS 33 is inactive, its relocation means only that a radio link will be established with BTS 22 when necessary to originate or terminate a call. If MGS 33 is actively engaged in an ongoing communication, however, or in the process of call set-up as it moves from one cell to the other, PLMN 100 will attempt to maintain this communication through a process called “handoff”.

Using a predetermined algorithm, MGS 33 will determine (or be notified) that handoff is appropriate and will then switch from one BTS to another. Handoffs may be “soft” or “hard”. A hard handoff means that the radio link 38 to BTS 20 is broken before a new link to BTS 22 is established. Preferably, the discontinuity in service is barely perceptible to the subscriber. (It may be highly disruptive to data transmissions, however, because individual data packets may not remain intact.) In a soft handoff, active MGS 33 will establish radio link 39 with BTS 22 while it is still located in cell 10 (and may establish radio links with other BTSs in other cells as well). MGS 33, BTS 20, and BTS 22 cooperate to continually evaluate the relative signal strength of radio links 37 and 39 to determine, according to a predetermined algorithm, when handoff is appropriate. Because radio link 39 is established before radio link 37 is broken, this type of transfer is preferable to the hard alternative because it lessens the interruption of service to the subscriber and lowers the risk of dropping the call entirely. Because they use code division, as opposed to frequency division, CDMA networks typically provide for soft handoffs, and may be preferred for sending essential gaming data even where the player's telephone service is provided through another scheme.

As MGS 33 moves from cell 10 to cell 12, this change in location (or, more properly, change in serving BTS) is preferably reflected in the visitor location register (VLR) 28, a database connected with (or incorporated as a part of) MSC 29. The VLR 28 will normally keep track of the cell-location for any mobile gaming station operating in the MSC-VLR service area. From time to time, this location information may also be sent to the relevant home location register (HLR) 45 for storage. The HLR is associated with the wireless network as a whole (or a significant position of it), and includes relevant data related to each mobile gaming station operated by network subscribers. (Mobile gaming stations not subscribing to the network may be “roaming” or operating outside of their network-coverage area. The locations of these stations may be tracked in a similar manner as long as operation in the area continues.) By keeping track of the serving BTS for mobile gaming stations, of course, PLMN 100 can more efficiently establish a connection to a target mobile gaming station.

Inactive mobile gaming stations may also relocate from one cell to another, or even from one network-covered area to another. In this case, the MGS location information in a VLR such as VLR 28 may be updated when the mobile gaming station registers. Registration is simply the process of sending out a signal by the mobile gaming station when it is powered-up, and periodically thereafter. The registration signal is picked up by a nearby BTS (and often by more than one), which relays the location information to, for example, VLR 28 through MSC 29. In some cases the registration may occur even when the mobile gaming station is (otherwise) powered-down, though this is not typical in contemporary systems.

Periodically, VLR 28 will also notify the home location register (HLR) 45, a central database of PLMN 100 that tracks not only the location of mobile gaming stations that subscribe to the PLMN 100, but also subscription information such as the services subscribed to MGS capabilities, and so forth. In accordance with one embodiment of the present invention, HLR 45 also maintains information about which position-determining procedures may be used to locate a registered mobile gaming station, including for example, the mobile gaming station's capabilities and which position-determining services the player has subscribed to.

When a call directed to a particular mobile gaming station is placed, the location information in HLR 45 and the various VLRs is checked so that the call can be appropriately routed. A page or other incoming-call notification is broadcast by the BTS serving the cell where the mobile gaming station's location was last recorded and, if the mobile gaming station responds, a radio link terminating the call is established. If the mobile gaming station does not respond to this page, the PLMN 100 may send out paging messages in other cells in an attempt to locate the target mobile gaming station. If, after a period of time, all such pages are unsuccessful, the PLMN 100 returns an appropriate message so that the originating caller can be notified that the target mobile gaming station is unavailable. If the service is available, the disappointed call originator may be given the opportunity to leave a voice or numeric message that is recorded on a centrally accessible database (not shown) from which it can be transmitted to the intended call recipient at a later time.

In practice, of course, the BTS actively communicating with a mobile gaming station knows that the mobile gaming station is located in, or at least near, the BTS' cell or coverage area. It should also be apparent that a BSC, perhaps in connection with another, is capable of determining approximately when a mobile gaming station travels from one cell to another. In this manner, a modem wireless system already performs a position determination of sorts for each subscriber. At any time, the HLR 45 will have a stored ‘last-known location’, which may be confirmed by querying the various VLRs to ascertain if more accurate information is available. The mobile gaming station itself can also be paged to ascertain or verify the cell it is currently in. For convenience this method of locating a mobile gaming station will be referred to herein as “cell-ID”. A cell may vary from half of a kilometer to 10 kilometers in diameter, however, meaning that the received position determined in this manner may not be very precise.

Returning to the embodiment of FIG. 1, game server 70 is in communication with PLMN 100 through a network 50, for one example the Internet. There is no requirement that it be connected in this way, of course, but communicating through such a widely-accessed network permits an enormous potential player base. Game server 70 uses game database to store game-related information including player location information where available. For that reason, game database 75 may optionally be connected in a more direct way (shown by broken line) to HLR 45. In such a configuration, game database 75 may simply mirror selected information already maintained in HLR 45, specifically that information relevant to the location of PLMN subscribers that are also mobile gaming subscribers. In an alternate embodiment, HLR 45 is updated when more current or accurate information is available in game database 75. In another alternate embodiment (not shown), game server 70 is connected directly to MSC 29. This may be the case where the PLMN 100 operator is operating the mobile gaming application for PLMN subscribers. In this embodiment, out-of-PLMN mobile gaming stations may still participate, for example by communicating through network 50 and gateway 49.

Game server 70 may or may not be considered part of PLMN 100. It may, for example, enable the PLMN operator to provide a mobile gaming service for which it charges a subscription fee. In another embodiment, a third party provides the mobile game service to the PLMN operator, presumably for a fee, and connects to PLMN 100 and any number of other networks though IP network 50. In either case, game server 70 may also be connected to other facilities that may be used for game-related communication with mobile game players, for example shopping mall 60 and central antenna 65. Where these are utilized, of course, the mobile gaming station will preferably be able to communicate with them when in range. This range may vary; central antenna 65 may have far-reaching capability, while a subscriber would have to be inside mall 60 to communicate through it. As should be apparent, alternate communication facilities can be used where a radio link to PLMN 100 cannot be established, perhaps while inside a building or on-board an airplane. These alternate communication facilities may, of course, be used for position determinations as well. For example, shopping mall 60 may have position sensors at the entrance of each individual store located there.

In the shopping mall 60 or similar environments, there may be available position-determination system, one designed for use within a limited area only. This system may have been installed simply for game play, but may also have been put in place to facilitate advertising and promotion, or to track consumer traffic. In one embodiment, this system (not shown) includes a substantial number of strategically placed sensors that communicate with each other and nearby MGSs via the Bluetooth protocol or some other short-range radio protocol such as IEEE 802.11b.

Bluetooth (named after an early Scandinavian King) is a communications protocol developed by a consortium of telecommunications companies for governing short-range radio communication between compatible devices. The expectation of the Bluetooth developers is that the great majority of electronic devices will eventually include this capability. When two (or more) such devices come with in range, typically about 10 meters, they detect each other's presence and begin wireless communication using a standard handshake protocol. This naturally includes an identification sequence so that devices that are supposed to recognize each other may do so. For example, a computer and a printer together determine that the former is attempting to send a document to the latter for printing. They can then exchange the necessary data to accomplish this function.

Although the number of Bluetooth devices is expected to increase dramatically, overly-congested airwaves are not anticipated. The limited range of Bluetooth devices, coupled with a sophisticated frequency-hopping scheme, prevents them from being overwhelmed with communications from a multitude of other Bluetooth devices. Note their limited range is partly due to their low power output, but this also means that power consumption is low—a distinct advantage. Another way that Bluetooth devices may reduce power consumption is by only utilizing for transmission the power necessary to reach a particular device effectively. That is, where two or more devices have detected each other's presence and established the need for actual data transmission, they can reduce the power needed for transmission by measuring the distance separating them and adjusting their output power accordingly. As many Bluetooth devices will operate in relatively close proximity, substantial savings may be realized. The present invention takes advantage of systems like Bluetooth by using its distance-measuring capability to reckon the position of an MGSIn a preferred embodiment, the sensors can also determine the direction from which a signal is being sent, for example by analyzing the strength of a given signal with respect to a variety of directions. Even where such sophistication is not available, some estimation of the MGS's position may be made from knowledge of which sensors are close enough to it to have established communication. Again, it is not a requirement that the Bluetooth protocol itself be used.

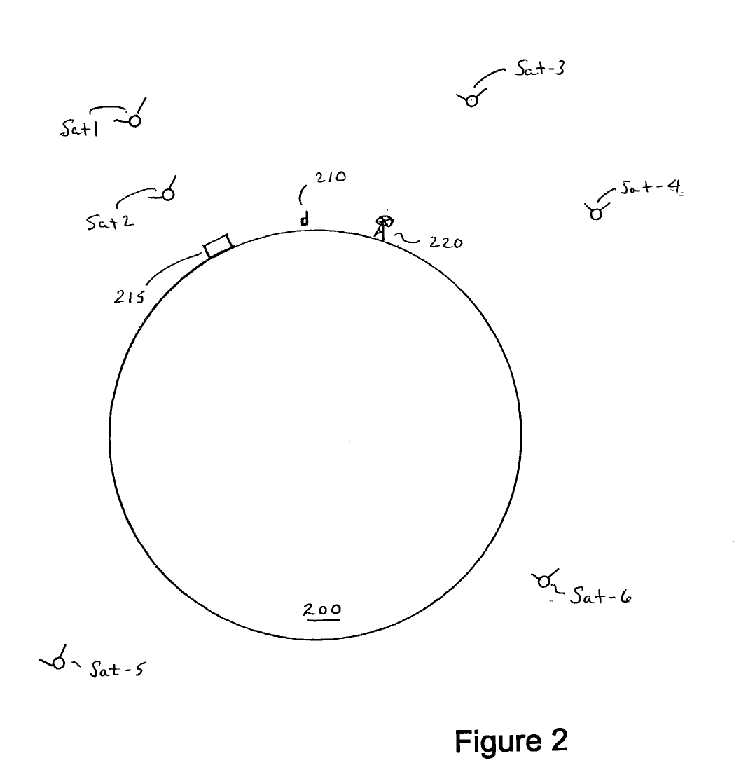

Other position determination systems are also available. Among the most well known is GPS (Global Positioning System), which uses an array of earth-orbiting satellites to ascertain the location of a GPS receiver located almost anywhere on the earth's surface. FIG. 2 is a sketch illustrating the operation of position determination using the GPS. There are normally at least 24 GPS satellites orbiting the earth 200 at any one time, though for clarity only six are shown in FIG. 1, denominated Sat-1 through Sat-6. Each GPS satellite continuously transmits an encoded signal from which a properly-equipped receiver may determine precisely when the signal was sent and the location of the satellite. The satellites are controlled through one of several terrestrial control stations, such as control station 215 shown in FIG. 2.

The GPS satellites are positioned in orbit such that MGS 210, which in one embodiment is also a properly-equipped GPS receiver, is always in a line-of-sight relationship to at least four of them. In FIG. 2, MGS 210 receives signals from Sat-1 through Sat-4, but not from Sat-5 and Sat-6, which are too far over the horizon from the perspective of MGS 210. Using the time taken for a given satellite signal to reach it, MGS 210 uses the satellites position information to calculate the distance that separates them. That distance defines an imaginary sphere around the transmitting satellite on whose surface MGS 210 must be located (and more specifically, at point along the intersection of the imaginary sphere and the surface of earth 200).

By repeating the calculation for each of the satellite signals it is receiving, MGS 210 will be able to reckon its own position on the surface of the earth at the intersection of the imaginary spheres. The accuracy of this position determination, of course, is dependant on the quality of the receiving equipment and atmospheric conditions that may affect the satellite transmissions. improved accuracy may be obtained if the MGS 210 also communicates with fixed receiver 220, which is positioned at a known location. Because its location is known and it receives signals from some or all of the same satellites as MGS 210, fixed receiver can provide corrective information that MGS 210 can use to improve its determination.

In another embodiment, some of the position-reckoning calculations are done within the PLMN 100 (shown in FIG. 1), for example by relaying the received GPS satellite information through the network to game server 70, which presumably has more computational power than MGS 210. Game server 70 may then report this information to the player, or simply store it in game database 75 for later reference. (The mobile gaming application may not universally notify the player where they are even if their position is precisely known to the network.) Of course, the position information, once determined, may be shared with the PLMN 100 or other networks as well.

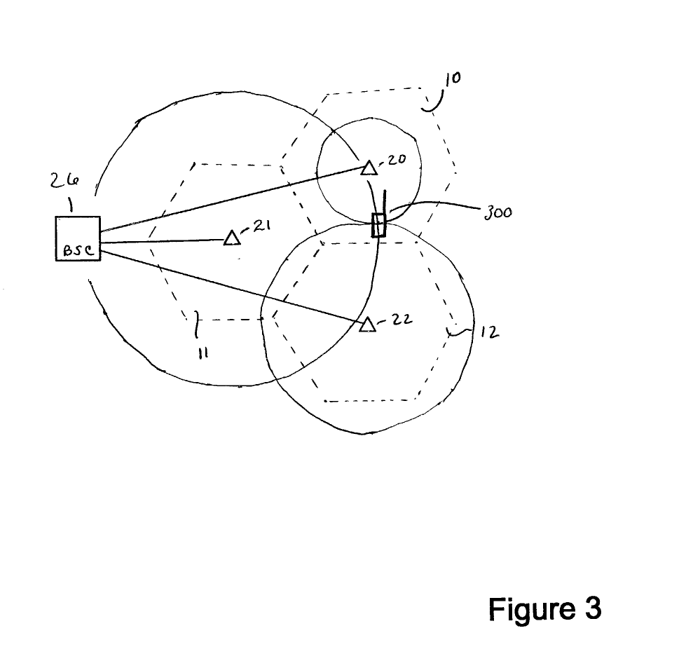

Similar methods may be implemented in somewhat simpler fashion within the network itself. For example, FIG. 3 is a simplified block diagram illustrating the operation of position determination using an enhanced—observed time difference (E-OTD) system in a wireless communication system, for example the PLMN 100 of FIG. 1. In this illustration, MGS 300 is located in cell 10, which is covered by BTS 20. Because MGS 300 is communicating with BTS 20, its location within cell 10 is known with relative certainty, although further precision is not obtainable without further information. MGS 300 is also close to cell 12, however, and may be or recently has been in communication with BTS 22 as well as BTS 20. On the one hand, this could introduce some ambiguity as to which cell the MGS is actually in. On the other hand, however, it might fairly be assumed that MGS 300 is within a circle (not shown) having a diameter extending from BTS 20 to BTS 22. This reckoning, if performed, is simply a modified cell ID method, and although it relieves some measure of ambiguity, it provides no greater precision. If a handoff from one BTS to the other has recently occurred or appears imminent, the location estimate may be refined. It should be noted, however, that handoff algorithms typically take into account more than just the absolute received signal strength. In other words, the handoff may for other reasons (such as cell congestion) occur well before the traveling MGS has actually gotten closer to a second BTS than to the one handing off a connection. Even a stationary MGS may be handed off to obtain a more favorable connection from a more distant BTS.

The PLMN 100 may be used to provide a better location determination, however, regardless of which BTS the MGS is actually using. In the enhanced-observed time difference method, BTS 20 and BTS 22 both send out a burst signal. When each signal is received MGS 300 calculates the difference in the time taken by each of them to traverse the distance from its transmitting base station. BSC 26, which knows the cell geometry and burst signal synchronization, and already possesses cell ID information regarding MGS 300, may then make a reasonably accurate estimate of its location. If the distance from the MGS 300 to each BTS can be determined, of course, the position may be fixed with greater precision at the intersection of two circles having their respective centers at one of the BTSs and a radius equal to the distance from the MGS. As should be apparent, using a burst signal from BTS 21 (in cell 11) will increase the accuracy of this position fix. Note the forgoing explanations of GPS and EOTD are to place the invention in context. Methods using these systems may vary, however, and the exact manner in which they are utilized is not material as long as it remains in accordance with the present invention.

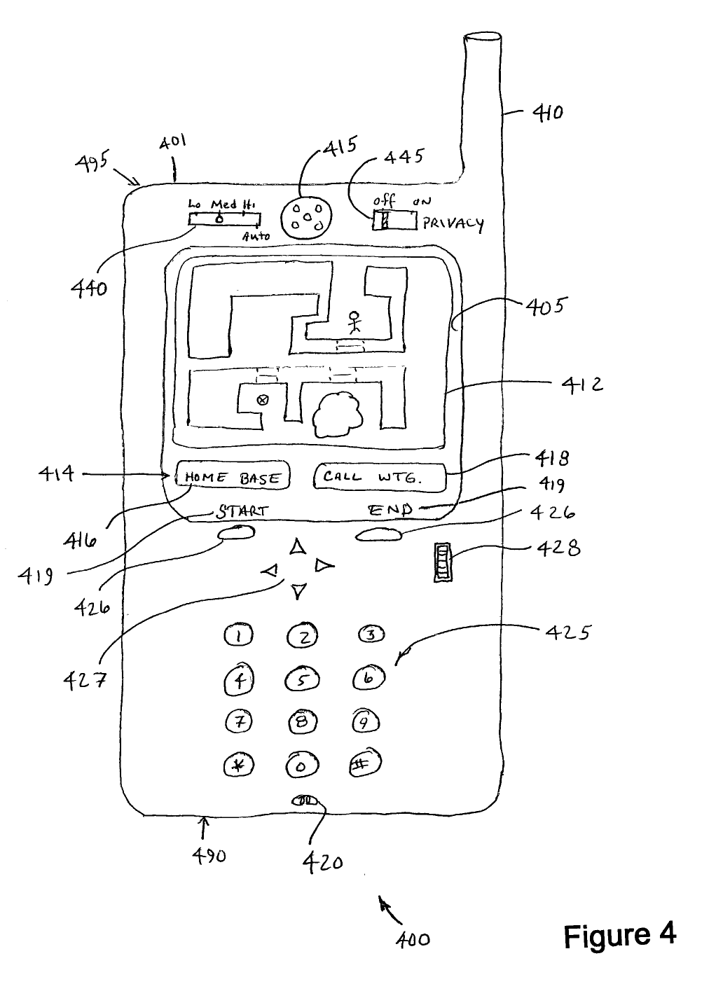

FIG. 4 is an illustration of a mobile gaming station such as one that may be used for location-based mobile gaming in accordance with an embodiment of the present invention. Mobile gaming station 400 shown in FIG. 4 includes an antenna 410 for facilitating radio frequency (RF) communication with the network. The liquid-crystal display (LCD) 405 of mobile gaming station 400 is large enough to permit the display of graphic images and pictures, as opposed to just the letters and numbers associated with older-style mobile telephones. The other user interfaces present include speaker port 415 (an opening formed of the enclosure 401 of mobile gaming station 400 adjacent to an internal speaker (not shown). Audio input is accomplished through microphone port 420 located near the bottom 490 of mobile gaming station 400. The user may enter alphanumeric information on the alphanumeric keyboard 425, and is presented with a number of other user interface devices such as function keys 426, scroll keys 427, and perhaps even a thumb wheel 428. In the embodiment of FIG. 4, located on either side of speaker port 415, are switches related to connecting a game according to an embodiment of the present invention. The mode switch 440 allows the user to manually select the position-determining mode that is desired.

As previously mentioned, different position determination schemes provide a varying degree of prevision in estimating the exact location of the user (that is, of the mobile gaming station itself). The most accurate position-determining schemes, however, are often a great deal more expensive to operate, and even though much of the operational equipment will be owned or controlled by the network operator, this additional expense may not be passed on to all network subscribers in general. Rather, subscriptions can be sold to a specific location-based mobile gaming service that for an extra fee allows the utilization of the precise position determining equipment. On the other hand, every user may be subscribed to the position determining service, perhaps for a nominal fee, with the use of various services built on a time of use basis. Using the manual mode selection switch 440, the user can indicate which level of service it wishes to use, or select and ‘automatic’ setting to let the network make the decision. This may be a service that is used for all applications, or it may represent a service that is used as needed by the specific game or application being run. In other words, where a particular application execution does not require precise location determination, the application itself may simply use the mobile gaming station's cell ID, available on the HLR. This was referred to earlier as an example of low-level precision, and may be useful for many game applications or stages of a particular game. In other cases, of course, no position information will be needed at all for a particular operation, and accordingly, no position determining system or method will be used.

Also near top 495 of enclosure 405, is located privacy switch 445. Although optional, privacy switch 445 may be desirable for reasons that will be apparent. The electronic device depicted in FIG. 4 is intended for use in mobile gaming, and especially in location-based mobile gaming. As such, from time to time extremely accurate and precise location reckoning may be undertaken with respect to the mobile gaming station. The subscriber carrying the mobile gaming station may not object to this location being revealed, either directly or in an indirect manner, to other persons involved in playing the game. In other cases, however, the mobile gaming station subscriber may not want to reveal an exact location or even a general location, and may wish to be selective as to who is entitled to ascertain this information. This is a simple matter of privacy and safety.

The privacy perspective should be readily apparent, the safety perspective perhaps involving potential unauthorized access to the position information. In addition, in some mobile gaming applications, a player at a certain level or point in the game may not be required to reveal position information. For example, in one phase of a mobile gaming application, players may be required or encouraged to find and even meet other game players in the vicinity. At other times, a reward may be given to a player who finds another, putting the found player at a disadvantage with respect to the game's score. The player who does not at the moment wish to be located, may have accomplished a certain task that allows them to disconnect the location-based services so that they may relocate without being tracked by the system. For all of the above reasons, and others as well, the mobile gaming station will preferably have the capability to refrain from engaging in location-based positioning services automatically, such as in the course of a game, and manually, for example through the use of switch 445.

In the embodiment of FIG. 4, display 405 is divided into two or more different portions. In practice, these divisions may be real physical divisions involving actual separate display units, or it may be a single display screen that is so divided. Game-board portion 412 is the part of the display that is used for pictorial depictions of where in the game the mobile game player is located. Status bar 414 in this embodiment includes a position indicator 416 as well as an ongoing-call status 418. The position information that is depicted on game-board 412 may also be converted to alphanumeric format and displayed on position data status bar 416 in some fashion recognizable to the player. Ongoing-call status bar 418 may, for example, depict the status of an ongoing game-related or non-game-related communication. This may simply be an indication that the mobile gaming station is communicating with the network at a particular point, or may indicate that a voice call is “waiting” or on hold. Additional status bars may be positioned on display 410 as is desirable. Finally, function indicators 419 indicate the current function that function keys 426 are ready to perform.

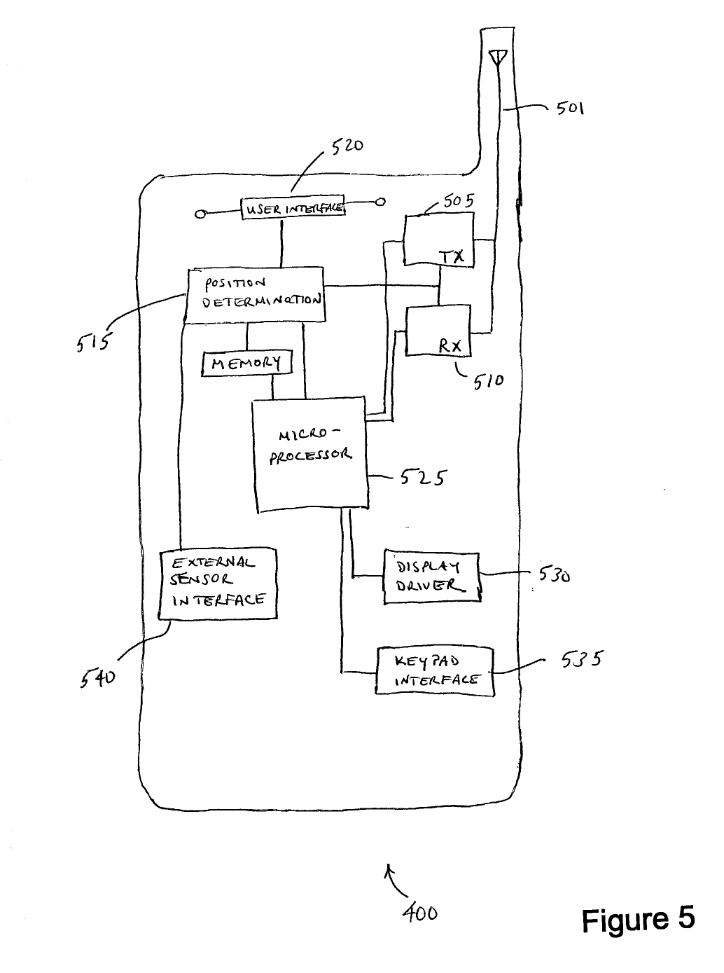

FIG. 5 is a block diagram of the mobile gaming station 400 schematically illustrating the interconnection of selected components used to carry out the various functions associated with mobile gaming and other applications. Transmit function 505 and receive function 510 are connected to antenna 501 such that wireless communications may be sent and received. The position determination functions of the MGS 400 are performed by the position determination module 515 under the direction of microprocessor 525. Position determination module 515, which is preferably controlled by mode switch 440 and privacy switch 445 (shown in FIG. 4) through user input interface 520, is also connected to transmitter 505 and receive function 510, which it utilizes as necessary in executing the position-determination function. Position determination function 515 is also in communication with external position sensor interface 540. The use of external sensor platforms with mobile gaming station 400 will be explained below in more detail. Mobile gaming station 400 is, in general, controlled by microprocessor 525. Microprocessor 525 also controls display driver 530 and receives input through key interface 535

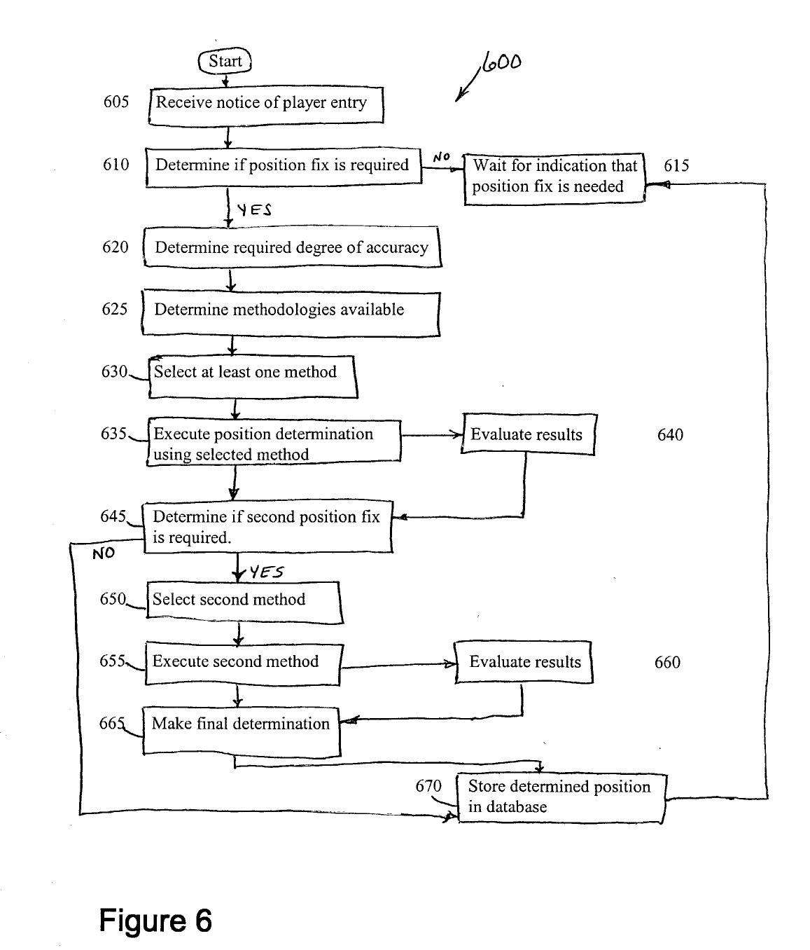

FIG. 6 is a flow chart illustrating a method 600 of location-based mobile gaming in accordance with an embodiment of the present invention. At START, it is presumed that a wireless communication system has been provided to communicate with an MGS and with a game server. As mentioned above, the game server may or may not be an integral part of the wireless communication network itself. The same is true for all of the mobile gaming functions, of course, in that there need only be some way to access then through ordinary means. There is no requirement, in other words that they be resident in a particular component or in a particular server. By the same token, reference to the “gaming network” implies only that a network supporting the gaming station is involved, not that it is or is not separate from the wireless communication network itself.

At step 605 the gaming network receives notification that a player has entered the game. As used here, a player who enters the game may be active or inactive, or participate at any allowed level of activity. A player who leaves the game is no longer in any sort of active consideration by the game server and can have no further influence on the virtual space. Generally, however, the game will continue from the state it was in at the player's departure, and there may be residual effects from the player's actions taken before or upon leaving. In the context of the present invention, no location reckoning is performed with respect to a player who has left the game. The precise action that a player must take to leave the game may vary according to the application. For example, turning a MGS on and off may cause the player to enter and leave the game, or simply to go active and inactive, respectively. Note that assuming the equipment is capable and the rules permit, a player may be entered, and even active, in more than one mobile gaming application at a time, even using a single MGS.

When notification is received that a player has entered the game, the game server determines whether a position fix (location determination) is required (step 610). Required in this sense means immediately required or potentially necessary at some time in the near future. If a particular application entered by a player does not initially take into account the player's location, system resources need not be spent to determine it. Some applications may even have a location-based and a non-location-based version. In the depicted embodiment, if no location determination is currently required, the location-determination function simply awaits a notice to proceed (step 615). In an alternate embodiment, (not shown) location determination may be conducted, at least at some level, and the results stored against the advent of a subsequent requirement. If a position determination is required, then the required degree of precision/accuracy is determined (step 620). Next, the methodologies available for use in position determination are ascertained (step 625). Availability of a particular method depends on the capabilities of the network itself, including the MGS. It may also depend on the environment in which the MGS is currently operating, and a query may have to be formulated and transmitted to determine if, for example, the MGS is inside a building and unable to utilize the GPS but may utilize a Bluetooth-based system (step not shown). Information regarding availability may be stored in the HLR 45 or game database 75 (shown in FIG. 1) or both.

One or more of the available position-determining methodologies are then selected (step 630), and a position determination is executed (step 635). Execution may be performed by one component such as the MGS or the game server, or may be done by several cooperating components. In a preferred embodiment, the results, which can be referred to as a “presumed position” are then evaluated according to predetermined criteria (step 640). This evaluation may be as simple as comparing the presumed position to previously gathered data or to the cell ID information stored on the HLR 45. It may also be more involved, for example taking into account the player's customary travel patterns, environmental conditions, time of day, and so forth. Whether the evaluation is performed or not, however, the network then determines if a second position determination is needed (step 645). This may be required by the game application or the state is in, such as where a high degree of precision or accuracy is called for. A second determination may also be needed if an evaluation at step 640 reveals grounds for calling the initial presumed position into question.

If no further determination is required, the presumed position is taken as final, until updated with subsequent data. The final determination is stored (step 670) in a database such as game database 75 (shown in FIG. 1). The process then returns to step 615 and waits for an instruction to begin again. If a second determination is required, selection of an available methodology is made (step 650). The second method used is typically though not necessarily different from the first one. One selected, the second position-determining method is executed (step 655) and evaluated (step 660). At this point the evaluation may take into account the first found presumed location, and compare it with the second. A final determination is then made (step 665) and stored appropriately (step 670). At this stage, the final determination (again, ‘final’ until further updated) may be a choice between the two presumed positions or a combination of them. Naturally, if the two positions match exactly, or are consistent with each other (one perhaps being more precise), the final determination is apparent. Where the two presumed positions are in conflict, selection or combination rules are used to make the final determination. Taken into account in this case may be, for example, the nature of the methods used, the results of evaluation steps 640 and 660, and any known player or operator preferences. Although not shown, the process may also proceed to resolve conflicts by selecting and executing a third position determination method (which may simply repeat one of the first two). In some cases, of course, additional selection and execution steps may be undertaken even where no conflict is perceived. Finally, at CONTINUE, the process simply awaits the next indication that a position determination is needed, returning to step 615. This may be when the player has reached a point in virtual space where a position determination is required, or when the system is in the process of selecting or evaluating the method by which data is being sent to the MGS. The network or the application may also simply require periodic updates, or may request a new determination when the first appears to be incorrect.

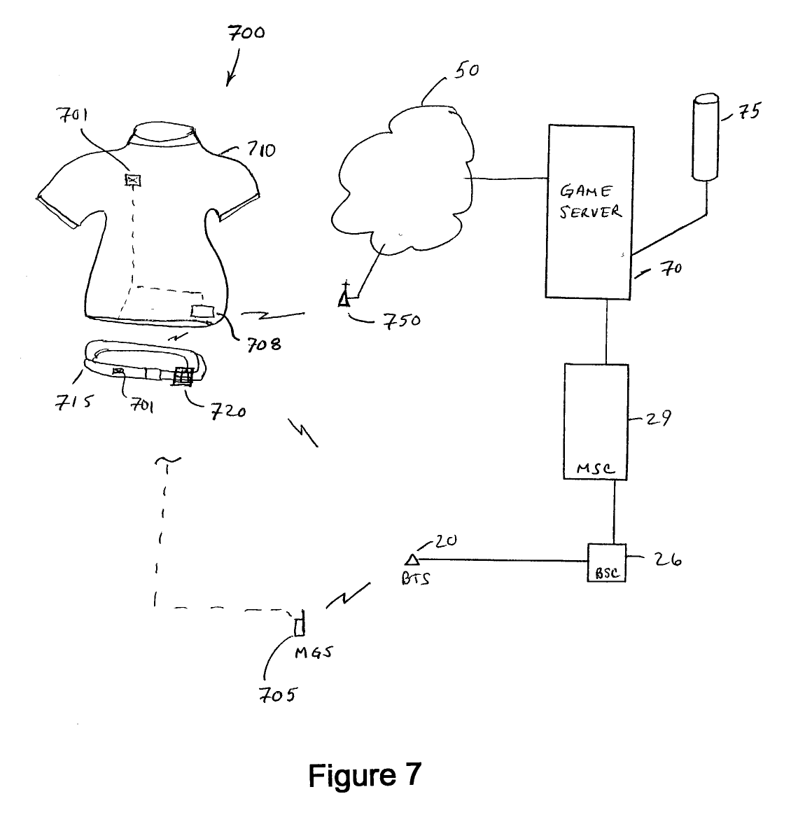

In a particularly preferred embodiment of the present invention, an external sensor platform 700 is used to enhance the system's ability to make a precise and accurate location determination. As illustrated in FIG. 7, which is a simplified block diagram showing the relationship between selected components of this enhanced embodiment, the sensor platform 700 may, for example, include a shirt 710, belt 715, or other article of clothing into which sensors 701 have been embedded, or simply a clip-on short range module 720. Although the sensor platform 700 may communicate through transmitter 708 directly with MGS 705, in the embodiment of FIG. 7, the mobile gaming station and the sensor platform also communicates directly but independently with the central game server 70, either through BTS 20 or network 50 via a Bluetooth sensor 750. In this way, the mobile game may continue in the absence of the sensor platform, either because the user has chosen not to don it or because it has been given to another for example as a deception (presumably one in line with the rules of the mobile gaming application itself). The that the specialized sensors on the enhanced sensor platform 700 can be easily exchanged as the player moves from building to building or general location to general location.

The sensor platform 700 may be used with the location determination system of the present invention in a variety of ways. For example, it is entirely possible that large facilities ordinarily entertaining a large number of guests, such as sports arenas, concert halls, convention centers, and hotel complexes, may wish to add position determination equipment to facilitate certain game playing applications that can be enjoyed by patrons without unduly interfering with other events or functions of the facility. A game player entering sports arena, for example, could be given a special shirt, or simply belt or clip-on sensor so that their position can be determined with great accuracy assuming that the facility itself has been outfitted with appropriate sensing devices. The enhanced sensor platform will ordinarily, although not necessarily, be owned by the facility with which its individual sensor gear cooperates. In that way, local variation is both possible and relatively inexpensive. The player, on the other hand, does not need to invest in a variety of different sensor platforms to be compatible with the locations they frequently visit. Of course, other arrangements are possible.

Typically, the enhanced sensor platform 700 will be issued to the player having the mobile gaming station, and may be capable of interfacing directly with it (for example) through external sensor interface 540 shown in FIG. 5). In another embodiment, the enhanced sensor platform 700 may be worn by a companion to the player having the MGS, thus introducing the possibility of team play using a single mobile-gaming device 705. In this scenario, the approximate location of the mobile gaming station 705 could be determined by ordinary means, for example, cell ID, as explained above, while the location of the enhanced sensor platform 700 may be more precisely determined. In a particularly preferred embodiment, the enhanced sensor platform 700 may also communicate with the mobile gaming station 705 using a protocol such as Bluetooth or IEEE 802.11b protocol. Assuming the proper range and capability, the enhanced sensor platform can then cooperate with the mobile gaming device in order to determine and report a precise and accurate location of both systems.

The description above is directed at one or more preferred example for implementing the present invention, and it is not intended in providing these specific examples that the scope of the invention should necessarily be limited to them alone. Rather, the scope of the present invention is defined by the following claims.

What is claimed is:

1. In a communication network capable of supporting a mobile gaming application, a system for optimizing location-based mobile gaming, said system comprising:
a position-determining module for determining the position of a mobile gaming station in communication with the network, said position-determining module capable of position determination utilizing a plurality of position-determination methodologies.

2. The system of claim 1, wherein the position-determining module is resident on the mobile gaming station.

3. The system of claim 1, wherein the system further comprises a game server, and wherein the position-determination module is resident on the game server.

4. The system of claim 1, wherein at least one of the position-determining methodologies uses the global-positioning system (GPS).

5. The system of claim 1, wherein at least one of the positioning methodologies uses an enhanced observable time differential (E-OTD) system.

6. The system of claim 1, further comprising a determiner for determining which of the plurality of the position-determination methodologies to us for position determination.

7. The system of claim 6, wherein said determiner determines which position-determining methodology to use based at least in part on a selection made by the user.

8. The system of claim 6, wherein said determiner determines which position-determining methodology to use automatically.

9. The system of claim 8, wherein aid automatic determination is based at least in part on the gaming application being used by the mobile gaming station.

10. A method for enabling location-based mobile gaming through a communication network, said method comprising the steps of:
providing a plurality of access nodes for use by a mobile gaming station in accessing the network;
providing a game server in communication wit the network for controlling operation of the gaming application;
determining presumed locations of at least one mobile gaming station using a plurality of position-determining methodologies; and
determining a mobile-station location fix for use with the gaming application.

11. The method of claim 10, wherein the mobile-station location fix is determined by selecting one of the presumed locations.

12. The method of claim 11, wherein the selection is based on input provided by the user.

13. The method of claim 12, wherein the selection is based on the state of the gaming application being used.

14. The method of claim 10, wherein the mobile-station location fix is determined as a function of at least two presumed locations according to a predetermined algorithm.

15. The method of claim 14, wherein each position-determining methodology is assigned a precision factor and the predetermined algorithm uses the precision factors in determining the mobile gaming station location fix.
